(19) United States
(12) Patent Application Publication
(10) Pub. No.: US 2022/0012456 A1
(43) Pub. Date: Jan. 13, 2022

(54) PARTICLE CHARACTERIZATION USING OPTICAL MICROSCOPY

(71) Applicant: Cambridge Enterprise Limited, Cambridge (GB)

(72) Inventors: Tuomas Pertti Jonathan Knowles, Cambridge (GB); Pavan Kumar Challa, Cambridge (GB); Kadi Liis Saar, Cambridge (GB); Quentin Alexis Peter, Cambridge (GB); Clemens Kaminski, Cambridge (GB); Oliver Vanderpoorten, Cambridge (GB)

(73) Assignee: Cambridge Enterprise Limited, Cambridge (GB)

(21) Appl. No.: 17/296,208

(22) PCT Filed: Nov. 22, 2019
(86) PCT No.: PCT/GB2019/053305

§ 371 Date: May 21, 2021

(30) Foreign Application Priority Data
Nov. 22, 2018 (GB) 1819033.0

(51) Int. Cl. G06K 9/00; G01N 15/02; G02B 21/00

(52) U.S. Cl. CPC G06K 9/0014; G02B 21/008; G02B 21/0016; G01N 15/0227

(57) ABSTRACT

A method of optically characterizing individual molecules/molecular complexes, or other particles, in solution. The method comprises flowing a solution comprising the molecules/molecular complexes into an imaging region of a microfluidic channel, wherein the imaging region of the microfluidic channel has a first lateral dimension of greater than 1 μm in an x-direction wherein the x-direction is perpendicular to a direction of the flow; capturing a succession of images of the individual molecules/molecular complexes in the imaging region; tracking movement of the individual molecules/molecular complexes in at least the x-direction in the imaging region using the succession of images; and characterizing the individual molecules/molecular complexes from the tracked movement. In some implementations the characterizing comprises determining a diffusion coefficient of the molecules/molecular complexes from the tracked movement.

### FIELD

This invention relates to generally to the characterization of individual molecules/molecular complexes in solution using optical microscopy.

The work leading to this invention has received funding from the European Research Council under the European Union's Seventh Framework Programme (FP7/2007-2013)/ERC grant agreement no 337969. The project leading to this application has received funding from the European Union's Horizon 2020 research and innovation programme under grant agreement No 766972. The project leading to this application has received funding from the European Union's Horizon 2020 research and innovation programme under the Marie Sklodowska-Curie grant agreement No 674979.

### BACKGROUND

Individual molecules/molecular complexes are typically not visible using optical microscopy. A technique for optically imaging single molecules immobilised on a glass cover slip is described in Vahid et. al., “Direct optical sensing of single unlabelled proteins and super-resolution imaging of their binding sites” Nature Communications 5, 4495 (2014); and Cole et al., “Label-Free Single-Molecule Imaging with Numerical-Aperture-Shaped Interferometric Scattering Microscopy” ACS Photonics 2017 4(2), 211-216, and also in WO2018/011591. However localizing the particles on the surface potentially modifies the molecules under investigation. A technique for optically imaging single molecules using a capillary is described in WO2017/041809. However this involves flowing a target particle through a capillary with a bore of <500 nm and performing single-point detection. Such a capillary tube is difficult to make, and the scattering signal comprises a single event, or series of events, caused by individual particles moving through the focus of an illuminating laser beam. Further background can be found in WO2018/190162; US2017/307509; US2018/0136114; EP3276389; and WO2017/136664.

### SUMMARY

In one aspect there is therefore described a method of optically characterizing individual molecules/molecular complexes, or other particles, in solution. The method may comprise flowing a solution comprising the molecules/molecular complexes into an imaging region of a microfluidic channel. In implementations the imaging region of the microfluidic channel has a first lateral dimension of greater than 1 μm in an x-direction, where the x-direction is perpendicular to a direction of the flow. The lateral dimension in the x-direction may be greater than 2 μm, 3 μm, 5 μm, or 10 μm. The method may further comprise capturing a succession of images of the individual molecules/molecular complexes in the imaging region. The method may further comprise tracking movement of the individual molecules/molecular complexes in at least the x-direction in the imaging region using the succession of images. In some implementations the molecules/molecular complexes are not tracked in a z-direction, where the z-direction is perpendicular to the direction of the flow and to the x-direction. The method may comprise viewing the individual molecules/molecular complexes in the z-direction. The method may further comprise characterizing the individual molecules/molecular complexes from the tracked movement.

The location of a point corresponding to an individual molecule/molecular complex can be seen using optical microscopy even if the molecule/complex itself cannot be resolved, e.g. using fluorescence or iSCAT microscopy. Thus (provided the concentration of molecules/complexes is low) the locations of individual molecules/complexes can be tracked even if they cannot be resolved directly. Thus by providing a microfluidic channel of sufficient width, motion of a molecule/complex can be observed in at least this (width) direction. This enables the observed molecule/complex to be characterized according to a characteristic of its motion.

For example, the tracked movement can be used to determine a diffusion coefficient for the observed molecule/complex (or other particle), for example a 1D or 2D diffusion coefficient. Characterizing a molecule/complex according to a characteristic of its motion is useful because it allows information such as the size, and/or shape, and/or interaction of the molecule/complex with the solvent to be determined. Depending upon the application these may be more or less disentangled from one another. Generally however an estimate of a size, such as an average or maximum dimension or volume or effective radius, may be determined either directly or by first determining an estimate for the diffusion coefficient. The determined size may be an effective or hydrodynamic size.

Characterizing a molecule/complex according to a characteristic of its motion can also allow dynamic events to be visualized in solution, for example the joining or separation of molecules/molecular complexes and/or other particles, e.g. binding events

The techniques described herein are particularly useful when applied to molecules/molecular complexes but in principle they may be applied to other very small particles, for example particles having a maximum dimension which is less than a wavelength of light used for the imaging, or less than half this wavelength. Such particles may include metallic or other nanoparticles, colloid particles, polymer particles, viruses, and exosomes and other extra-cellular vesicles. In some implementations, however, the technique is used to characterize biomolecules/molecular complexes such as proteins, antibodies and the like. The solution may be an aqueous solution.

In some implementations of the method the particles may also be tracked in a y-direction, along the direction of the flow. A problem that can occur with such tracking is that if the flow profile is not uniform across the width of the channel, motion across the width of the channel can chance the speed of motion of the particle in the y-direction. For example a hydrodynamic, pressure-driven flow results in a parabolic flow profile with a gradual reduction in solution flow speed as the channel walls are approached. Thus in some implementations of the method a approximately flat flow profile is generated across the x-direction, for example by driving flow of the solution using electro-osmosis. In this way the rate of flow changes little across the x-direction except very close to the channel walls. Whatever the flow profile, the flow profile may be modelled so that its effect may be compensated, for example by subtracting an estimated flow in the y-direction, determined using the model, from a measured motion in the y-direction. The model may be a model of the electro-osmotic flow profile. Such techniques can therefore facilitate characterizing motion of the particles in 2D, for example to determine a 2D diffusion coefficient.

Some implementations of the method track movement of the particles whilst the fluid is flowing through the microfluidic channel (capturing images whilst the fluid is flowing); in other implementations flow of the fluid is halted whilst the particles are tracked (and imaged).

In some implementations of the method a plurality of microfluidic channels is provided, fluidically coupled to a manifold. Thus the method may comprise flowing the solution into a manifold (an array of channels), and flowing the solution from the manifold (array of channels) into a plurality of the imaging regions in a respective plurality of the microfluidic channels coupled to the manifold (array of channels). This can increase throughput, for example by increasing the chance that a particle diffuses into a channel, particularly if the channel is a blind channel. A single imaging system may be shared between the channels, or multiple imaging systems may be employed to track particle movement in multiple channels simultaneously.

In some implementations the channels have respective fluid outputs, for example via a second manifold coupled to the channels. This facilitates flushing out the channels for re-use, and thus high-throughput. In other implementations some or all of the channels are blind channels, i.e. they have a dead end rather than an output. In this case the channels may be air permeable to allow the channels to be filled with solvent (PDMS, polydimethylsiloxane, microfluidic channels have this property). This can facilitate determining a diffusion coefficient since the flow is stationary.

In general, however, the use of a microfluidic approach facilitates upstream processing of the solvent prior to characterization. For example such an upstream processing may comprise a process to separate a set of particles, e.g. molecules, for analysis using the method. Such a separation process may comprise a continuous separation process, for example involving one or more electric fields applied perpendicular to a direction of the flow, or a batch separation process, for example involving an electric field applied along the direction of the flow. Use of such a separation process prior to characterization helps to reduce complexity of the sample before analysis, and can thus increase the quality of characterization data obtained, e.g. a diffusion coefficient or particle size estimate.

In some implementations, but not essentially, the images are captured using interferometric scattering optical microscopy. In broad terms interferometric scattering optical microscopy (iSCAT) is a technique in which an imaged particle is illuminated with coherent light and the signal results from interference between light scattered from the particle and a reference light reflected from a nearby interface. This interference can result in signals which are amplified compared with some other approaches. The imaged particle may be label-free, i.e. the technique is capable of label-free detection of single biological molecules such as proteins/protein complexes. Generally, though not essentially, the method is used off-resonance, i.e. away from an absorption peak/edge of the particle.

Thus in some implementations of the method the imaging region has a light-reflecting interface. This may be, for example, an interface defined by an inner boundary of the microfluidic channel, i.e. an interface between the inner boundary of the channel and the solution. In principle, however, it may be an outer boundary of the microfluidic channel. In implementations capturing an image using interferometric scattering optical microscopy may thus comprise illuminating a particle (molecule/molecular complex) in the imaging region with coherent light using an objective lens such that the light is reflected from the interface and scattered by the molecule/molecular complex. The reflected light and the scattered light is captured using the objective lens provided to an imaging device to image the interference between the reflected and scattered light. (The illumination may comprise a collimated beam at an oblique angle to the interface; i.e. an angle of incidence between the beam and a normal to the interface may be between 0 degrees and 90 degrees). The imaging device may be a 1D or 2D imaging device, for example a camera.

Capturing the images using interferometric scattering optical microscopy may further comprise confining motion of the particle in a direction along the optical axis, i.e. z-direction, to less than a distance 2λ, 3/2λ, λ,

$$\frac{λ}{2} , or \frac{λ}{4}$$

where λ is the wavelength of the coherent light (in the solution). This may be done, for example, by suitably sizing a height of the microfluidic channel (in the z-direction). A range of

$$\frac{λ}{2}$$

represents a range of maximum contrast to zero contrast in the interference image. Restricting the particle motion in this way, e.g. to within

$$\frac{λ}{4} ,$$

facilitates tracking the particle because the particle is inhibited from disappearing from view (and reappearing elsewhere). In practice it can be difficult to fabricate microfluidic channels with such a small height but it is not essential for the z-direction movement to be limited to

$$\frac{λ}{2} or \frac{λ}{4}$$

for useful benefit to be obtained.

In implementations of the method (and corresponding system described later) a focus of the iSCAT microscope is set away from an edge of the microfluidic channel (in the z-direction), for example centrally in the channel in the z-direction.

In implementations of the method each of the succession of images of the particles is itself determined by capturing a sequence of interference images, that is a sequence of images of interference generated by light scattered by the particles. The sequence of interference images is then processed to provide an image for the succession of images used for the movement tracking.

In some implementations the sequence of interference images is averaged to define a background image which may then be subtracted from each interference image of the sequence. The sequence of interference images may be captured over a time period for which the interference from a particle fluctuates between a maximum and minimum light intensity one or more times, but some benefit can be obtained when capturing over shorter time periods.

The sequence of interference images, in implementations with the background subtracted, may then be processed to determine a location map image representing a map of intensity maxima and/or minima across the sequence of interference images; these represent particle locations. Optionally location map images representing intensity maxima and intensity minima may be combined.

The location map images may then be low-pass spatially filtered, for example using a Gaussian kernel. This is useful in merging multiple detections of the same particle at slightly different locations when the sequence of interference images extends over multiple maximum/minimum intensity cycles.

As previously described, the movement tracking may be used to determine an estimated size for a particle, for example from the diffusion coefficient. The iSCAT images may be used to determine an estimate of the polarizability of a particle, or used to determine an estimate of the mass of a particle if it is assumed that the mass of a particle (rather than its volume) is an approximate proxy for polarizability. For example the contrast of interference the signal from a particle in one or more of the interference images can be used to determine an estimate of the mass of the particle.

From the estimates of size e.g. volume of a particle and mass of a particle an estimated mass:size ratio for the particle may be determined. This can be used to classify, or potentially identify a particle such as a molecule or molecular complex.

In a related aspect there is provided a system for optically characterizing individual molecules/molecular complexes, or other particles, in solution. The system comprises a microfluidic channel having an imaging region, wherein the imaging region of the microfluidic channel has a first lateral dimension of greater than 1 μm in an x-direction, wherein the x-direction is perpendicular to a direction of flow in the imaging region of the microfluidic channel. The system may include a drive system to flow a solution comprising the molecules/molecular complexes into the imaging region. An optical image capture is included to capture a succession of images of the individual molecules/molecular complexes in the imaging region. A processor is configured to track movement of the individual molecules/molecular complexes in at least the x-direction in the imaging region using the succession of images and to determine data characterizing the individual molecules/molecular complexes from the tracked movement.

The system may have a plurality of the microfluidic channels coupled to a microfluidic manifold, each channel having a respective imaging region. The drive system may comprises an electro-osmotic drive system, for example to control flow of the solution to move a sample of the solution into the imaging regions, optionally to halt flow of the solution for capturing the images, and optionally then to subsequently control flow of the solution to flush the sample of solution out of the imaging regions in preparation for analysing a subsequent sample of the solution.

In implementations the optical image capture system comprises an interferometric scattering (iSCAT) optical microscope and the imaging region has a light-reflecting interface as described above. The iSCAT microscope may comprise a source of coherent light, such as a laser, and an objective lens to direct the coherent light to illuminate the imaging region such that the light is reflected from the interface and scattered by a molecule/molecular complex in the imaging region. The objective lens is configured to capture the reflected light and the scattered light. An imaging device is configured to image interference between the reflected light and the scattered light.

An optical path between the objective lens and coherent light source may include a beam splitter to separate the returned reflected and scattered light from the incident illuminating light. The imaging device may comprise a 1D or 2D image sensor, e.g. an EMCCD (Electron Multiplying Charge Coupled Device) sensor or a fast CMOS camerea, and an optical element such as a lens or mirror to focus the returned light onto the sensor.

The iSCAT microscope may have a contrast-enhancing mechanism, for example as described in in Liebel et al., “Ultrasensitive Label-Free Nanosensing and High-Speed Tracking of Single Proteins”, Nano Letters 2017, 17(2), 1277-1281; or as described in the co-pending application by the same applicants as the present application, filed on the same day as the present application, which is incorporated by reference.

As noted above, some implementations of the methods/systems described herein use iSCAT microscopy, but this is not essential. Thus some other implementations of the methods/systems use fluorescence imaging/microscopy, for example TIRF (total internal reflection fluorescence) microscopy. Some implementations using fluorescence imaging do not confine motion of the particle in the z-direction, but z-direction confinement as described above can be useful in constraining the particles to an imaging plane. In this case the wavelength referred to may be that of the incident excitation light or that of the fluorescence. Again, micrometre scale channels may be used for fluidic accessibility whilst nanometre scale channels may be used for imaging. Fluorescence-based techniques can provide high sensitivity and/or high specificity in detection of analyte molecules, and can be used to obtain, e.g. a diffusion coefficient as described above. The flow of the solution/particles may be controlled by the geometry and/or (electro-osmotic) fluidic drive to slow or stop particles for this purpose. Other previously mentioned advantages such as the ability to perform high-throughput measurements on a solution can also be obtained. Thus upstream processing of the solvent prior to characterization may be employed as previously described. The use of multiple, “parallelized” microfluidic channels can facilitate obtaining multiple measurements to reduce statistical uncertainty in the measurements/characterization.

### DRAWINGS

These and other aspects of the system will now be further described by way of example only, with reference to the accompanying figures, in which:

FIG. 1 a schematic diagram of an interferometric scattering (iSCAT) optical microscope;

FIG. 2 shows a schematic diagram of a system for optically characterizing individual molecules/molecular complexes in solution;

FIGS. 3a and 3b show interference images from the system of FIG. 2;

FIG. 4 shows a flow diagram of a procedure for processing interference images from the system of FIG. 2 for movement tracking; and

FIGS. 5a and 5b show processed images from the system of FIG. 2, showing movement of an antibody molecule.

In the figures like elements are indicated by like reference numerals.

### DESCRIPTION

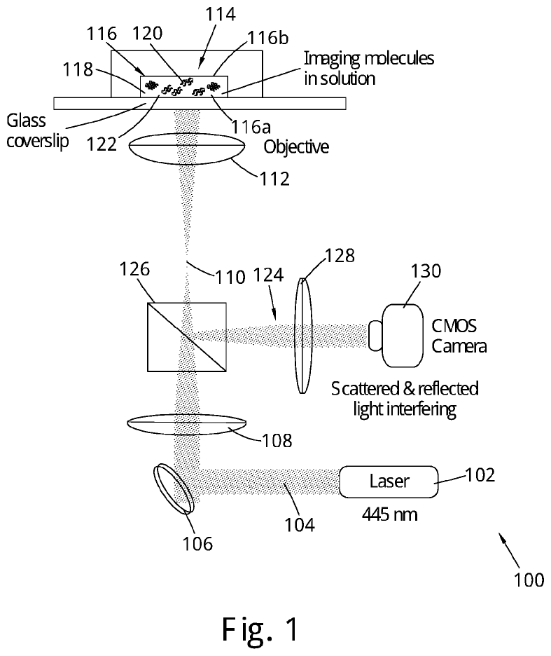

Referring to FIG. 1, this shows a schematic diagram of an interferometric scattering (iSCAT) optical microscope 100. The microscope comprises a continuous wave laser 102 which provides a beam 104 of coherent light to a focusing element, lens 108, which focusses the beam at the back focal plane 110 of a microscope objective lens 112. In this example the laser is in the visible, at 445 nm, and mirror 106 folds its optical path to lens 108. In an example the objective lens has 250 times magnification.

The objective lens 112, which may be an oil immersion objective, focusses the illumination on a detection region 114. In the example of FIG. 1 the detection region 114 is defined by a chamber or channel 116 with upper and lower surfaces 116a,b, fabricated, for example, from glass or polymer. The chamber/channel 116 may contain a solution 118, such as an aqueous solution, containing one or more particles 120 to be imaged. In some other arrangements particles to be images may be immobilised on a glass surface, such as the surface of a cover slip. In some implementations the distance between surfaces 116a,b may be of order half a wavelength of the coherent light in the solution, to maintain an imaged particle in view.

The illumination is reflected from a reflecting interface 122, e.g. between the lower surface 116a of the chamber/channel 116 and the solution 118. The illumination is also scattered by the particle(s) 120. Both the reflected light and the scattered light is captured by objective lens 112, passed back along the optical path of the illumination, and directed into a separate path 124, in this example by a beam splitter 126. The reflected light and scattered light is then imaged. For example the reflected light and scattered light is focused onto an image sensor 130 by imaging optics such as a lens 128. The image sensor (camera) may be, for example a CMOS image sensor or an EMCCD image sensor; it may have a frame rate sufficient to capture and track movement of an imaged particle as described later.

In some implementations the beam splitter 126 may be replaced by e.g. a filter cube to collect fluorescence.

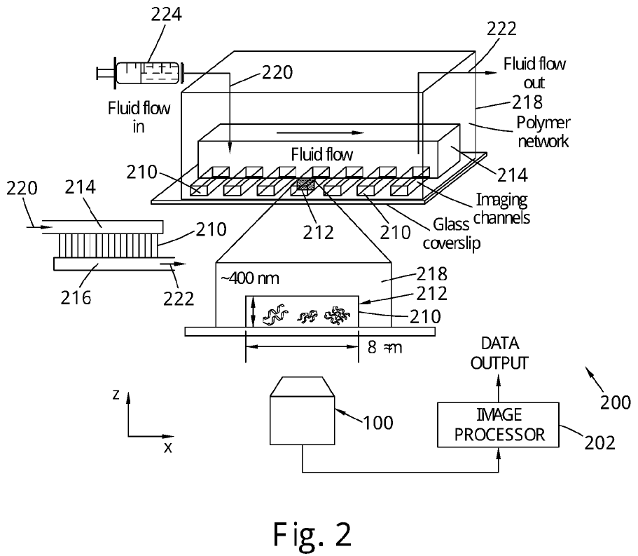

FIG. 2 shows a schematic diagram of a system 200 for optically characterizing individual molecules/molecular complexes in solution. The example system comprises an iSCAT microscope 100 of the general type shown in FIG. 1. The iSCAT microscope, more particularly the image sensor of the iSCAT microscope, provides captured interference images from the iSCAT microscope to an image processor 202. Image processor 202 processes the captured images as described later to output data comprising processed images and/or data characterizing particles in the image such as data representing one or more of particle mass, particle size, particle polarizability, and a particle diffusion coefficient. Image processor 202 may comprise a suitable programmed general purpose computer system, or a dedicated processor implemented in hardware and/or software.

The system includes a set of microfluidic channels 210 coupled to an inlet manifold 214. Each channel has a respective imaging region 212, also shown in cross-section in FIG. 2. The channels may be blind channels as illustrated, or may be coupled to an outlet manifold 216 as shown schematically in the inset diagram. As indicated in the figure, the microfluidic channels may have a restricted height of only a few hundred nanometres, for example ˜400 nm. By contrast they have a width of several microns, e.g. ˜8 μm. Ideally the height could be less than 400 nm but such structures can sag. By contrast the manifold may have a height of a few microns, e.g ˜5 μm.

The manifold 214 has a fluid inlet 220 and, optionally, a fluid outlet 222 (via the outlet manifold in the inset). Solution is driven into the inlet and may pass out through the outlet. Where the channels are blind channels they can nonetheless be filed with solution as air can diffuse out through the walls and ends of the microfluidic channels. The solution is driven by a fluid drive system 224, schematically illustrated by a syringe pump. However for such a fluid drive the flow speed profile across the lateral width of a channel is parabolic, decreasing towards the edges of the channel. In some implementations, therefore, an electro-osmotic drive system is employed not shown), which has a more uniform flow profile until very close to the channel edges. Such an electro-osmotic drive system may comprise a high voltage DC power supply with a first polarity (anode) terminal electrically coupled to the solution at one end (e.g. upstream) of the set of microfluidic channels and a second polarity (cathode) terminal electrically coupled to the solution at another end (e.g. downstream) of the set of microfluidic channels.

In an example implementation the microfluidic channels and manifold(s) may be formed in a polymer 218, such as PDMS. The channels may be formed using the standard soft lithography techniques for microfluidics, for example with a replica mould. Where the resist is spin coated the lower profile structures may be fabricated first. The replica mould may be used to fabricate a PDMS-based microfluidic structure, which may be sealed with glass e.g. a coverslip.

The use of restricted height channels limits motion of the images particles in the z-direction, reducing the risk that a particle becomes difficult to track by disappearing at one location (due to destructive interference) and reappearing at another, different location. There is also substantially no convection in such channels, so that the observed particle motion is governed by diffusion. The observed diffusion is in the x- and y-directions and constrained (on long time scales) in the z-direction; it may be observed in either 1D or 2D, depending upon the imaging system/sensor employed.

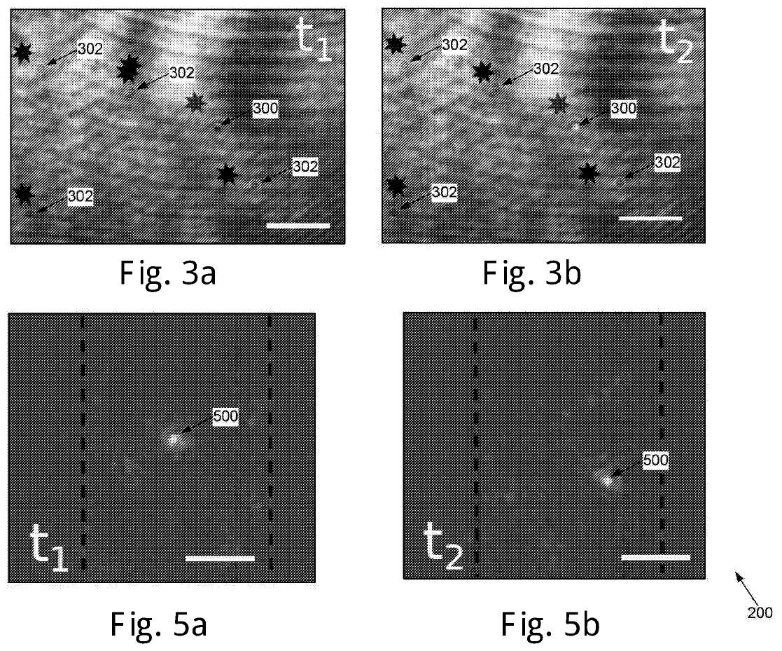

FIGS. 3a and 3b show interference images from the iSCAT microscope in the system of FIG. 2, showing the same imaged region at times t1 and t2 and illustrating the raw image fluctuations seen by the image sensor 130 (the scale bar is 2 μm). As can be seen a raw image comprises essentially static interference patterns and interference patterns 300 resulting from imaged particles. These interference patterns comprise concentric rings centred at a location of the particle. FIG. 3a shows two types of particle, static particles 302, for example particles attached to a surface, and moving particles 300. Also present, but not shown in FIGS. 3a and 3b, are interference patterns from the walls of the microchannel.

As shown in FIGS. 3a and 3b, when a particle 300 moves it can move from a location in which it creates constructive interference (FIG. 3b), to a location in which it creates destructive interference (FIG. 3a). If the image sensor (camera) 130 of the iSCAT microscope has sufficient frame rate, which depends on the speed of the particle in the solution, the corresponding fluctuation in light intensity can be detected.

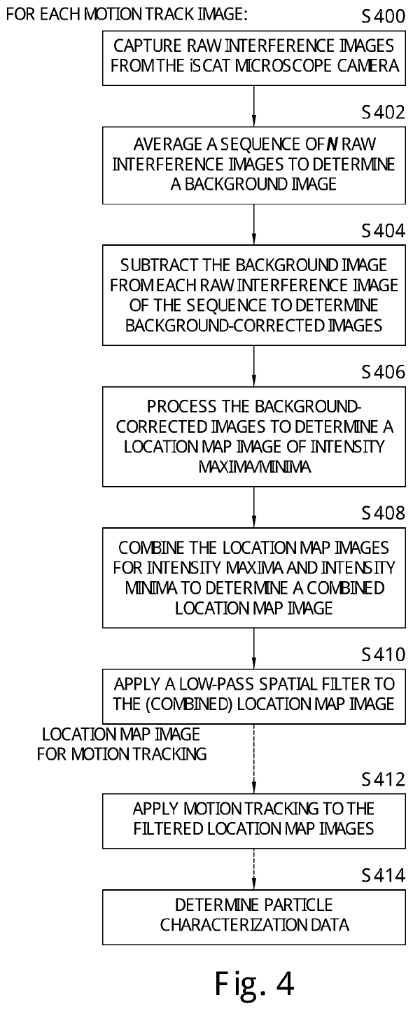

FIG. 4 shows a flow diagram of example image processing which may be implemented by the image processor 202 of FIG. 2 to determine data characterizing the imaged particles in solution in the microfluidic channel(s). In broad terms the image processing aims to enhance a representation of moving particles in the captured images and suppress a stationary background.

Starting at step S400 the procedure processes the raw interference images from the iSCAT microscope to determine images for use in particle motion tracking. In some implementations these raw images are part of a video stream, which may be a compressed video stream, e.g. an AVI-compressed video stream. In this case image frames may be decompressed before processing.

At step S400 the procedure captures i.e. inputs raw interference images from the iSCAT microscope and, at S402, averages a sequence of N such images to determine a mean background image. The iSCAT camera captures variation in the interference generated by an imaged particle moving in the solution and the averaging process reduces or removes such variation, reducing this to an average background level. Thus at step S404 the mean background image is subtracted from each of the raw images of the sequence to determine a sequence of background-corrected images. The number N of averaged images may be chosen such that there is significant interference intensity variation amongst the images; it may include more than one maximum/minimum intensity variation.

The background image may be considered as an instantaneous or local image as there may be a shift in the background over time. For example, for each frame, the background may be estimated by taking the median (or mean) of N local frames. For example, a video of length M might be separated in M/N segments. Each segment of length N may then be analysed.

Alternatively, a stack of N frames may be selected around each frame so that the frame is in the middle. After subtraction of the background image the image may be normalized by the square root of the intensity to obtain a more uniform noise intensity. Some implementations of the algorithm look for an intensity variation larger than the local noise, which is proportional to the square root of the local intensity. It can therefore be helpful to normalise the noise intensity on the image. Optionally the procedure may subtract a median of the resulting stack (image sequence) to suppress remaining invariant features.

A result of step S404 is a sequence of images in which the stationary background has been suppressed. These images are then processed to identify one or more locations of intensity variation. For example in one implementation the sequence of background-corrected images is processed to determine a location map image identifying locations of intensity maxima within the images (S406). The sequence of background-corrected images may also be processed to determine a location map image identifying locations of intensity minima within the images, where an intensity minimum is one in which the intensity falls below a previously subtracted background level (S406). Optionally these location map images may be combined or correlated, for example by multiplying values of corresponding pixels, to improve the location map (S408). Optionally an average, e.g. median, value of a location map image may be subtracted from each of the pixels to further suppress stationary features and artefacts, for example image compression artefacts.

The location map images may include multiple intensity maxima for the same particle at closely located positions. To avoid confusing the motion tracking the location map images may thus be spatially low-pass filtered, for example using a Gaussian kernel (S410). If necessary, for example if the frames coordinates are not stable, rotation and/or deformation detection may be used to perform image registration.

FIGS. 5a and 5b show examples of processed images, showing individual antibody complexes 500 in solution (there may be some aggregation) at different times t1 and t2; the scale bar is 2 μm.

Motion tracking may be applied to the location map images (S412), for example using off the shelf software such as TrackMate Tinevez, J Y.; Perry, N. & Schindelin, J. et al. (2016), “TrackMate: An open and extensible platform for single-particle tracking”, Methods 115: 80-90, PMID 27713081 (on Google Scholar). An output of the motion tracking may comprise, for example, coordinates of a particle in one or more dimensions, such as x and optionally y-dimensions, over time. This data may be used to determine other data characterizing a particle (S414), such as a mean square displacement of the particle over a period of time, or a mean square displacement of the particle in the x or y-direction over a period of time. Other features may be derived, for example speed of motion. Optionally a correction may be made for a known e.g. calibrated speed of flow in the y-direction; this may be a function of x.

In some implementations higher level particle characterization data may be determined, such as a diffusion coefficient for the particle; and/or an estimated effective size (dimension, area, or volume) for the particle may be determined. For 3D diffusion the diffusion coefficient is inversely proportional to particle size (radius); for 2D diffusion it is inversely proportional to log of the particle size.

In some implementations particle characterization data may also be obtained from the (raw) iSCAT images. In particular the iSCAT signal, that is the image contrast, depends upon the polarizability of the imaged particle. It appears that the polarizability of a particle such as a molecule/molecular complex as measured by iSCAT contrast depends on the mass of the particle. For example an approximately linear relationship between these has been observed by Piliaril and Sandoghdar, arXiv 1310.7460 FIG. 2d (perhaps because the number of dipoles present depends upon the mass). Thus the iSCAT image contrast, optionally calibrated, may be used to estimate for a mass of the imaged particle, albeit the signal may also be sensitive to the particle shape and illumination polarization.

Optionally an estimated particle mass, as determined above, and an estimated particle size, as determined above, may be used in combination to characterize the particle. For example a ratio of one to the other may be determined. This may be used to classify, or potentially even to identify, the particle.

Many alternatives will occur to the skilled person. The invention is not limited to the described embodiments and encompasses modifications apparent to those skilled in the art lying within the spirit and scope of the claims appended hereto.

1. A method of optically characterizing individual molecules/molecular complexes in solution, the method comprising:
flowing a solution comprising the molecules/molecular complexes into an imaging region of a microfluidic channel, wherein the imaging region of the microfluidic channel has a first lateral dimension of greater than 1 μm in an x-direction wherein the x-direction is perpendicular to a direction of the flow;
capturing a succession of images of the individual molecules/molecular complexes in the imaging region;
tracking movement of the individual molecules/molecular complexes in at least the x-direction in the imaging region using the succession of images;
characterizing the individual molecules/molecular complexes from the tracked movement.

2. A method as claimed in claim 1 wherein the characterizing comprises determining a diffusion coefficient of the molecules/molecular complexes from the tracked movement.

3. A method as claimed in claim 1 wherein the tracking further comprises tracking movement of the molecules/molecular complexes in a y-direction along the direction of the flow, and generating an approximately flat flow profile for the flowing solution in the x-direction.

4. A method as claimed in claim 3 wherein generating the approximately flat flow profile comprises flowing the solution using electro-osmosis.

5. A method as claimed in claim 1 comprising flowing the solution into a manifold, and flowing the solution from the manifold into a plurality of the imaging regions in a respective plurality of the microfluidic channels coupled to the manifold.

6. A method as claimed in claim 3 wherein the microfluidic channels coupled to the manifold are blind microfluidic channels.

7. A method as claimed in claim 1 wherein the microfluidic channel has an outlet, and wherein the tracking of movement of the molecules/molecular complexes is performed whilst the solution is flowing through the microfluidic channel.

8. A method as claimed in claim 1 wherein capturing the succession of images comprises capturing the images using interferometric scattering optical microscopy.

9. A method as claimed in claim 8 wherein the imaging region has a light-reflecting interface, and wherein capturing the images using interferometric scattering optical microscopy comprises, for each image, illuminating a molecule/molecular complex in the imaging region with coherent light using an objective lens such that the light is reflected from the interface and scattered by the molecule/molecular complex; capturing the reflected light and the scattered light using the objective lens; and providing the captured reflected and scattered light to an imaging device to image interference between the reflected light and the scattered light.

10. A method as claimed in claim 8 further comprising restricting movement of the molecules/molecular complexes in a z-direction in the imaging region, wherein the z-direction is a lateral direction perpendicular to the x-direction, wherein the restricting comprises limiting movement of the molecules/molecular complexes in the z-direction to a distance of less than 2λ, 3/2λ, λ, or
$$\frac{λ}{2} ,$$
where λ is the wavelength of coherent light used for the interferometric scattering optical microscopy.

11. A method as claimed in claim 8 wherein capturing the succession of images comprises, for each of the images of the succession of images, capturing a sequence of interference images, wherein an interference images comprises an image of interference generated by light scattered by the molecules/molecular complexes, and processing the sequence of interference images to provide the image of the succession of images.

12. A method as claimed in claim 11 wherein processing the sequence of interference images comprises determining a location map image representing a map of one or both of intensity maxima and intensity minima across the sequence of interference images.

13. A method as claimed in claim 12 wherein processing the sequence of interference images further comprises low-pass filtering the location map image.

14. A method as claimed in claim 8 further comprising determining a mass of an individual molecule/molecular complex from one or more images captured using the interferometric scattering optical microscopy.

15. A method as claimed in claim 14 wherein the characterizing comprises determining a ratio of the mass to a size of the individual molecule/molecular complex.

16. A method as claimed in claim 1 wherein capturing the succession of images comprises capturing the images using an interferometric scattering optical microscope, and wherein a focus of the interferometric scattering optical microscope is set away from an edge of the microfluidic channel in a z-direction perpendicular to the x-direction.

17. A method as claimed in claim 1 wherein the molecules/molecular complexes comprises a biological molecules/complexes, and wherein the solution comprises an aqueous solution.

18. A system for optically characterizing individual molecules/molecular complexes in solution, the system comprising:
a microfluidic channel having an imaging region, wherein the imaging region of the microfluidic channel has a first lateral dimension of greater than 1 μm in an x-direction, wherein the x-direction is perpendicular to a direction of flow in the imaging region of the microfluidic channel;
a drive system to flow a solution comprising the molecules/molecular complexes into the imaging region;
an optical image capture system to capture a succession of images of the individual molecules/molecular complexes in the imaging region;
a processor to track movement of the individual molecules/molecular complexes in at least the x-direction in the imaging region using the succession of images and to determine data characterizing the individual molecules/molecular complexes from the tracked movement.

19. A system as claimed in claim 18 comprising a microfluidic manifold and plurality of the microfluidic channels coupled to the microfluidic manifold each with a respective imaging region; and wherein the drive system comprises an electro-osmotic drive system.

20. A system as claimed in claim 18 wherein the imaging region has a light-reflecting interface, and wherein the optical image capture system comprises an interferometric scattering optical microscope, the microscope comprising: a source of coherent light; an objective lens to direct the coherent light to illuminate the imaging region such that the light is reflected from the interface and scattered by a molecule/molecular complex in the imaging region, wherein the objective lens is configured to capture the reflected light and the scattered light; and an imaging device configured to image interference between the reflected light and the scattered light.

21.-22. (canceled)
